(19) United States
(12) Patent Application Publication
(10) Pub. No.: US 2011/0212706 A1
(43) Pub. Date: Sep. 1, 2011

(54) Method and Apparatus for Providing a Regional Theft Guard

(75) Inventor: Janne Mika Uusilehto, Tampere (FI)

(73) Assignee: NOKIA CORPORATION, Espoo (FI)

(21) Appl. No.: 12/875,079

(22) Filed: Sep. 2, 2010

Related U.S. Application Data
(60) Provisional application No. 61/239,253, filed on Sep. 2, 2009.

(51) Int. Cl. H04W 12/06

(52) U.S. Cl. 455/411

(57) ABSTRACT

A method for providing a regional theft guard may include comparing, at a mobile electronic device, current device location to a set of enabled regions defined for the mobile electronic device, enabling operation of the mobile electronic device in response to a determination that the mobile electronic device is within an enabled region, and requesting entry of a security code in response to a determination that the mobile electronic device is not within the enabled region. A corresponding apparatus and computer program product are also provided.

### RELATED APPLICATION

This application claims the benefit of U.S. Provisional Application No. 61/239,253, filed Sep. 2, 2009, the contents of which are incorporated herein in their entirety.

### TECHNOLOGICAL FIELD

Embodiments of the present invention relate generally to device security and, more particularly, relate to an apparatus and method for enabling the provision of a mechanism for providing a regional theft guard.

### BACKGROUND

Communication devices are becoming increasingly ubiquitous in the modern world. In particular, mobile communication devices seem to be popular with people of all ages, socio-economic backgrounds and sophistication levels. Accordingly, users of such devices are becoming increasingly attached to their respective mobile communication devices. Whether such devices are used for calling, emailing, sharing or consuming media content, gaming, navigation or various other activities, people are more connected to their devices and consequently more connected to each other and to the world at large.

Due to advances in processing power, memory management, application development, power management and other areas, communication devices, such as computers, mobile telephones, cameras, personal digital assistants (PDAs), media players and many others are becoming more capable. However, the popularity and utility of mobile communication devices has not only fueled sales and usage of such devices, but has also caused these devices to be increasingly more common targets for thieves. Moreover, even if a device is not stolen, it may be lost or forgotten somewhere and another individual may discover the lost item and desire to use it.

Providing an increased level of security for mobile communication devices may reduce the motivation for stealing such devices and thereby free up law enforcement resources to focus on other crimes and also increase the feeling of safety and security among citizens. Accordingly, several approaches have been undertaken to improve device security. In one approach, a stolen phone may be added to a service provider blacklist so that the blacklisted phone will no longer be able to access the service provider's network. However, the blacklist is typically based on the IMEI (International Mobile Equipment Identity) number of the phone, which is typically accessible on the phone or on the packing material (which has likely been thrown away). Thus, since some users don't memorize the IMEI of their device, this is often not a viable solution. Some software solutions have also been developed. However, these solutions have typically been easy to defeat since thieves have been able to access the software and delete it, or such solutions have been relatively easy to attack and/or hack. Additionally, some solutions have required users to enter a code such as a personal identification number (PIN) prior to enabling the device for usage, but many users find it inconvenient or even annoying to be required to frequently enter the PIN.

Accordingly, it may be desirable to develop an improved mechanism for providing device security.

### BRIEF SUMMARY OF EXEMPLARY EMBODIMENTS

A method, apparatus and computer program product are therefore provided that may enable the provision of a regional theft guard for communication devices such as mobile terminals. Thus, for example, a mechanism may be provided for enabling a user of a device to define specific enabled regions in which usage of the device may be accomplished without entry of a code, and if the user later desires to modify the enabled regions, the code may be entered to enable the user to use the device in other regions. Some embodiments of the present invention may not only be used in the context of small or handheld mobile terminals, but may also be used in connection with larger and/or higher value mobile devices such as laptop computers or other devices.

In an example embodiment, a method for providing a regional theft guard is provided. The method may include comparing, at a mobile electronic device, current device location to a set of enabled regions defined for the mobile electronic device, enabling operation of the mobile electronic device in response to a determination that the mobile electronic device is within an enabled region, and requesting entry of a security code in response to a determination that the mobile electronic device is not within the enabled region.

In another example embodiment, an apparatus for providing a regional theft guard is provided. The apparatus may include at least one processor and at least one memory including computer program code. The at least one memory and the computer program code may be configured to, with the at least one processor, cause the apparatus at least to perform comparing, at a mobile electronic device, current device location to a set of enabled regions defined for the mobile electronic device, enabling operation of the mobile electronic device in response to a determination that the mobile electronic device is within an enabled region, and requesting entry of a security code in response to a determination that the mobile electronic device is not within the enabled region.

In another example embodiment, a computer program product for providing a regional theft guard is provided. The computer program product may include at least one computer-readable storage medium having computer-executable program code instructions stored therein. The computer-executable program code instructions may including program code instructions for comparing, at a mobile electronic device, current device location to a set of enabled regions defined for the mobile electronic device, enabling operation of the mobile electronic device in response to a determination that the mobile electronic device is within an enabled region, and requesting entry of a security code in response to a determination that the mobile electronic device is not within the enabled region.

In an example embodiment, an apparatus for providing a regional theft guard is provided. The apparatus may include means for comparing, at a mobile electronic device, current device location to a set of enabled regions defined for the mobile electronic device, means for enabling operation of the mobile electronic device in response to a determination that the mobile electronic device is within an enabled region, and means for requesting entry of a security code in response to a determination that the mobile electronic device is not within the enabled region.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic block diagram of a system according to an exemplary embodiment of the present invention;

FIG. 2 is a schematic block diagram showing an apparatus for enabling the provision of a regional theft guard according to an exemplary embodiment of the present invention; and

FIG. 3 is a flowchart according to an exemplary method of providing a regional theft guard according to an exemplary embodiment of the present invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information” and similar terms may be used interchangeably to refer to data capable of being transmitted, received and/or stored in accordance with embodiments of the present invention. Moreover, the term “exemplary”, as used herein, is not provided to convey any qualitative assessment, but instead merely to convey an illustration of an example. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein a “computer-readable storage medium,” which refers to a non-transitory physical storage medium (e.g., volatile or non-volatile memory device), can be differentiated from a “computer-readable transmission medium,” which refers to an electromagnetic signal.

According to an exemplary embodiment, a device that is lost or stolen may not be used in any region that was not previously enabled by the user. Thus, for example, users may define limitations upon the areas where the device can be used without input of a security code. A user may be enabled to define regions where the device can be used without input of the security code via selecting countries, states, cities or other definable regions for enablement from a list of such regions or from a map or other graphical user interface (GUI). Changes to the enabled regions may thereafter be made via input of the security code. Some examples of systems in which embodiments of the present invention may be practiced, and mechanisms for implementing example embodiments will be described hereinafter by way of example and not of limitation.

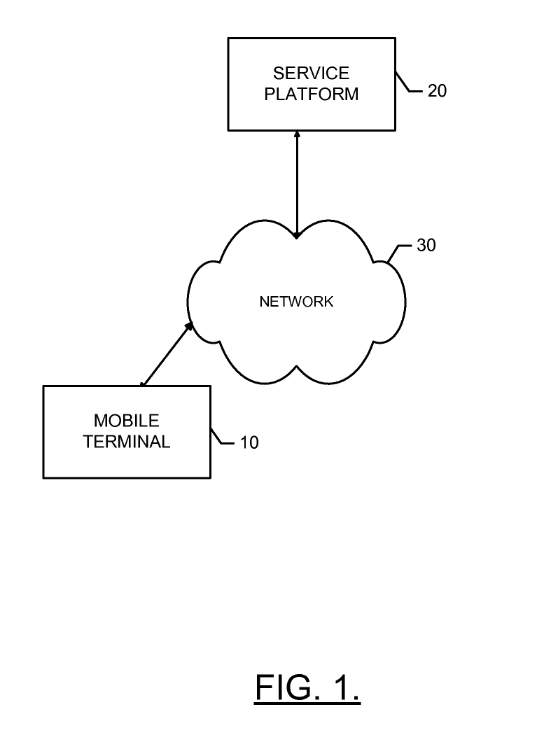

FIG. 1 illustrates a generic system diagram in which a device such as a mobile terminal 10 is shown in an exemplary communication environment. As shown in FIG. 1, an embodiment of a system in accordance with an example embodiment of the present invention may include a communication device (e.g., mobile terminal 10) configured to be capable of communication with a service platform 20 via a network 30. In some cases, embodiments of the present invention may further include one or more additional communication devices to which the mobile terminal 10 may communicate via the network 30. In some embodiments, not all systems that employ embodiments of the present invention may comprise all the devices illustrated and/or described herein. The mobile terminal 10 which is illustrated and hereinafter described for purposes of example, may be any of numerous types of devices, such as portable digital assistants (PDAs), pagers, mobile televisions, mobile telephones, gaming devices, laptop computers, cameras, video recorders, audio/video players, radios, global positioning system (GPS) devices, or any combination of the aforementioned, and other types of voice and text communications systems, can readily employ embodiments of the present invention.

Furthermore, the mobile terminal 10 may be a fixed or mobile device within a mobile platform. For example, the mobile terminal 10 may be a fixed communication device within an automobile or other mobile device.

The network 30 may include a collection of various different nodes, devices or functions that may be in communication with each other via corresponding wired and/or wireless interfaces. As such, the illustration of FIG. 1 should be understood to be an example of a broad view of certain elements of the system and not an all inclusive or detailed view of the system or the network 30. Although not necessary, in some embodiments, the network 30 may be capable of supporting communication in accordance with any one or more of a number of First-Generation (1G), Second-Generation (2G), 2.5G, Third-Generation (3G), 3.5G, 3.9G, Fourth-Generation (4G) mobile communication protocols, Long Term Evolution (LTE), and/or the like.

One or more communication terminals such as the mobile terminal 10 may be in communication with network devices and/or each other via the network 30 and each may include an antenna or antennas for transmitting signals to and for receiving signals from a base site, which could be, for example a base station that is a part of one or more cellular or mobile networks or an access point that may be coupled to a data network, such as a Local Area Network (LAN), a Metropolitan Area Network (MAN), and/or a Wide Area Network (WAN), such as the Internet. In turn, other devices such as processing elements (e.g., personal computers, server computers or the like) may be coupled to the mobile terminal 10 via the network 30. By directly or indirectly connecting the mobile terminal 10 and other communication devices to the network 30, the mobile terminal 10 may be enabled to communicate with the other devices or network devices such as the service platform 20, for example, according to numerous communication protocols including Hypertext Transfer Protocol (HTTP) and/or the like, to thereby carry out various communication or other functions of the mobile terminal 10 and the service platform 20, respectively.

Furthermore, although not shown in FIG. 1, the mobile terminal 10 may communicate in accordance with, for example, radio frequency (RF), Bluetooth (BT), Infrared (IR) or any of a number of different wireline or wireless communication techniques, including LAN, Wireless LAN (WLAN), Worldwide Interoperability for Microwave Access (WiMAX), WiFi, Ultra-Wide Band (UWB), Wibree techniques and/or the like. As such, the mobile terminal 10 may be enabled to communicate with the network 30, the service platform 20 and other devices by any of numerous different access mechanisms. For example, mobile access mechanisms such as Wideband Code Division Multiple Access (W-CDMA), CDMA2000, Global System for Mobile communications (GSM), General Packet Radio Service (GPRS) and/or the like may be supported as well as wireless access mechanisms such as WLAN, WiMAX, and/or the like and fixed access mechanisms such as Digital Subscriber Line (DSL), cable modems, Ethernet and/or the like.

In an example embodiment, the service platform 20 may be a device or node such as a server or other processing element. The service platform 20 may have any number of functions or associations with various services. As such, for example, the service platform 20 may be a platform such as a dedicated server (or server bank) associated with a particular information source or service (e.g., Nokia's Ovi service and/or a service associated with aiding in device recovery), or the service platform 20 may be a backend server associated with one or more other functions or services. As such, the service platform 20 represents a potential host for a plurality of different services or information sources. In some embodiments, the functionality of the service platform 20 is provided by hardware and/or software components configured to operate in accordance with known techniques for the provision of information to users of communication devices. However, at least some of the functionality provided by the service platform 20 may be data processing and/or service provision functionality provided in accordance with embodiments of the present invention.

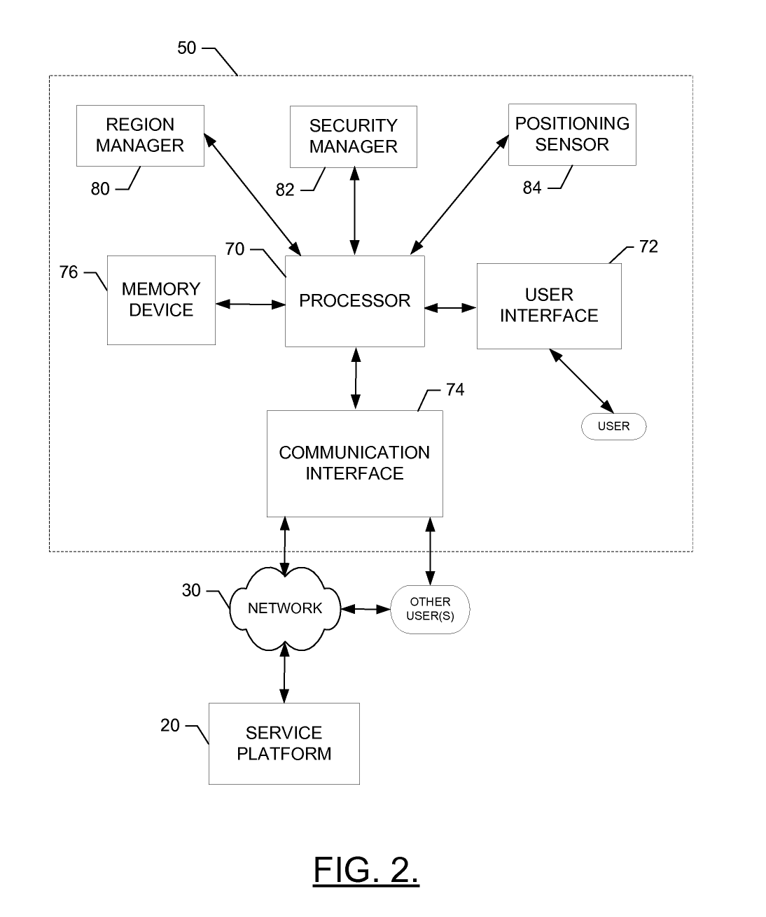

In an exemplary embodiment, the mobile terminal 10 may comprise an apparatus (e.g., apparatus 50 of FIG. 2) capable of employing embodiments of the present invention. In some cases, the mobile terminal 10 may provide information to and/or receive information from the service platform 20 relating to determinations regarding the status of the mobile terminal 10 with respect to theft or loss in the event the mobile terminal 10 is classified as being lost or stolen. However, in other situations, embodiments of the present invention may be practiced without assistance from any network device. As such, in some cases, the mobile terminal 10 itself may practice embodiments of the present invention without necessarily interacting with other devices.

In some embodiments, the mobile terminal 10 may include, for example, processing circuitry that may include one or more processors and one or more memory devices for storing instructions that are executable by the processor in order to cause the mobile terminal 10 to perform corresponding operations that are defined by the instructions. In some cases, the processor of the mobile terminal 10 may be embodied as, include, or otherwise control processing hardware such as one or more application specific integrated circuits (ASICs), microcontroller units (MCUs), or digital signal processors (DSPs) that are configured to provide a corresponding specific functionality.

FIG. 2 illustrates a block diagram of an apparatus that may benefit from embodiments of the present invention. It should be understood, however, that the apparatus as illustrated and hereinafter described is merely illustrative of one apparatus that may benefit from embodiments of the present invention and, therefore, should not be taken to limit the scope of embodiments of the present invention. In one exemplary embodiment, the apparatus of FIG. 2 may be employed on a mobile terminal (e.g., mobile terminal 10) capable of communication with other devices via a network (e.g., network 30). However, not all systems that may employ embodiments of the present invention are described herein. Moreover, other structures for apparatuses employing embodiments of the present invention may also be provided and such structures may include more or less components than those shown in FIG. 2. Thus, some embodiments may comprise more or less than all the devices illustrated and/or described herein. Furthermore, in some embodiments, although devices or elements are shown as being in communication with each other, hereinafter such devices or elements should be considered to be capable of being embodied within the same device or element and thus, devices or elements shown in communication should be understood to alternatively be portions of the same device or element.

Referring now to FIG. 2, an apparatus 50 for providing a regional theft guard is provided. The apparatus 50 may include or otherwise be in communication with a processor 70, a user interface 72, a communication interface 74 and a memory device 76. The memory device 76 may include, for example, one or more volatile and/or non-volatile memories. In other words, for example, the memory device 76 may be an electronic storage device (e.g., a computer readable storage medium) comprising gates configured to store data (e.g., bits) that may be retrievable by a machine (e.g., a computing device). The memory device 76 may be configured to store information, data, applications, instructions or the like for enabling the apparatus to carry out various functions in accordance with exemplary embodiments of the present invention. For example, the memory device 76 could be configured to buffer input data for processing by the processor 70. Additionally or alternatively, the memory device 76 could be configured to store instructions for execution by the processor 70.

The processor 70 may be embodied in a number of different ways. For example, the processor 70 may be embodied as one or more of various processing means such as a coprocessor, a microprocessor, a controller, a digital signal processor (DSP), a processing element with or without an accompanying DSP, or various other processing devices including integrated circuits such as, for example, an ASIC (application specific integrated circuit), an FPGA (field programmable gate array), a microcontroller unit (MCU), a hardware accelerator, a special-purpose computer chip, or the like. In an exemplary embodiment, the processor 70 may be configured to execute instructions stored in the memory device 76 or otherwise accessible to the processor 70. Alternatively or additionally, the processor 70 may be configured to execute hard coded functionality. As such, whether configured by hardware or software methods, or by a combination thereof, the processor 70 may represent an entity (e.g., physically embodied in circuitry) capable of performing operations according to embodiments of the present invention while configured accordingly. Thus, for example, when the processor 70 is embodied as an ASIC, FPGA or the like, the processor 70 may be specifically configured hardware for conducting the operations described herein. Alternatively, as another example, when the processor 70 is embodied as an executor of software instructions, the instructions may specifically configure the processor 70 to perform the algorithms and/or operations described herein when the instructions are executed. However, in some cases, the processor 70 may be a processor of a specific device (e.g., a mobile terminal or network device) adapted for employing embodiments of the present invention by further configuration of the processor 70 by instructions for performing the algorithms and/or operations described herein. The processor 70 may include, among other things, a clock, an arithmetic logic unit (ALU) and logic gates configured to support operation of the processor 70.

Meanwhile, the communication interface 74 may be any means such as a device or circuitry embodied in either hardware, software, or a combination of hardware and software that is configured to receive and/or transmit data from/to a network and/or any other device or module in communication with the apparatus. In this regard, the communication interface 74 may include, for example, an antenna (or multiple antennas) and supporting hardware and/or software for enabling communications with a wireless communication network. In some environments, the communication interface 74 may alternatively or also support wired communication. As such, for example, the communication interface 74 may include a communication modem and/or other hardware/software for supporting communication via cable, digital subscriber line (DSL), universal serial bus (USB) or other mechanisms.

The user interface 72 may be in communication with the processor 70 to receive an indication of a user input at the user interface 72 and/or to provide an audible, visual, mechanical or other output to the user. As such, the user interface 72 may include, for example, a keyboard, a mouse, a joystick, a display, a touch screen, soft keys, a microphone, a speaker, or other input/output mechanisms. In an exemplary embodiment in which the apparatus is embodied as a server or some other network devices, the user interface 72 may be limited, or eliminated. However, in an embodiment in which the apparatus is embodied as a communication device (e.g., the mobile terminal 10), the user interface 72 may include, among other devices or elements, any or all of a speaker, a microphone, a display, and a keyboard or the like. In this regard, for example, the processor 70 may comprise user interface circuitry configured to control at least some functions of one or more elements of the user interface, such as, for example, a speaker, ringer, microphone, display, and/or the like. The processor 70 and/or user interface circuitry comprising the processor 70 may be configured to control one or more functions of one or more elements of the user interface through computer program instructions (e.g., software and/or firmware) stored on a memory accessible to the processor 70 (e.g., memory device 76, and/or the like).

In an exemplary embodiment, the processor 70 may be embodied as, include or otherwise control a region manager 80, a security manager 82 and a positioning sensor 84. The region manager 80, the security manager 82 and the positioning sensor 84 may each be any means such as a device or circuitry operating in accordance with software or otherwise embodied in hardware or a combination of hardware and software (e.g., processor 70 operating under software control, the processor 70 embodied as an ASIC or FPGA specifically configured to perform the operations described herein, or a combination thereof) thereby configuring the device or circuitry to perform the corresponding functions of the region manager 80, the security manager 82 and the positioning sensor 84, respectively, as described herein. Thus, in examples in which software is employed, a device or circuitry (e.g., the processor 70 in one example) executing the software forms the structure associated with such means.

The region manager 80 may be configured to provide the user (e.g., via the user interface 74) with selectable options for defining enabled regions for the mobile terminal 10. An enabled region may be a region that is selected to be enabled for operation (e.g., for making calls, accessing wireless services, executing applications locally, or even accessing the home screen in some cases) without requiring the user to enter a security code. The security code may be a code provided to the purchaser of the mobile terminal 10, for example, on the box of the mobile terminal 10, in the user manual of the mobile terminal 10, or in the papers accompanying the mobile terminal 10 when purchased. In an exemplary embodiment, the security code may be provided in some prominent manner along with an explanation of the function of the security code with respect to registering enabled regions for access without security code entry. A copy of the security code may be stored in the memory of the mobile terminal 10 to permit comparison entered codes. However, in an exemplary embodiment, a hash of the security code may be stored in the mobile terminal 10 instead of the actual security code. Thus, even if a thief hacks into the mobile terminal 10, the thief would not be able to discover the security code since the security code would not exist anywhere in the mobile terminal 10.

In some cases, the security code may actually be a user generated passphrase or other cryptographic character sequence that may be generated based on or in replacement of the originally issued code. Thus, for example, the use may receive an original code when the mobile terminal 10 is purchased and may thereafter change the original code to the security code by providing a code that is more usable for the user than the original code. In some embodiments, the security code may include a predetermined number of characters (e.g., 10-20 characters) in order to improve security relative to a typical four digit PIN code.

The region manager 80 may provide a mechanism by which the user selects enabled regions. In some embodiments, the selection of enabled regions may be accomplished upon initial boot up even before the user is granted access to the home screen for the first time in order to ensure that the user provides selections for enabled regions. Alternatively, the selection of enabled regions may be accomplished responsive to selection of a menu option related to device security. A combination of the above described options and/or one or more other optional ways to initiate interface with the region manager 80 may also be provided. In this regard, for example, in some cases, the regional manager 80 may provide functionality related to enabled region selection in response to an attempt to use the mobile terminal 10 in a non-enabled region.

In some cases, the region manager 80 may provide a map (e.g., using a map application) and the user may be enabled to select specific countries, states, cities or other regional domains to be considered as enabled regions. Thus, for example, a map may be provided with various different zoom and navigation options to enable the user to select desired regions to designate as enabled regions. In embodiments where the mobile terminal 10 has a touch screen display, the user may simply select enabled regions with a stylus or other pointing device. Alternatively, the user may use a joystick or cursor to select enabled regions. Regions may initially be presented with a first color scheme or other distinguishing characteristic and selected regions may be indicated with a second color scheme or indicated in some other distinguishable manner (e.g., with flags, symbols, shading or other characteristics). In some embodiments, the map may be provided along with a pop-up window providing instructions for selection of the enabled regions and a definition of enabled regions or explanation of the effect of the selections the user is about to make. After the user has selected enabled regions, the map may be closed. The map may be re-accessed at any time via a menu option associated with device security options.

The map may provide navigation that enables various different levels of detail for enabled region selection. Thus, for example, the region manager may enable whole continents (e.g., Europe or North America) to be selected or smaller regions such as individual countries or states to be selected. However, in some embodiments, even smaller regions such as cities, counties or other relatively small regions could be selected. Thus, the map provided by the region manager 80 may be configured to provide navigation and zoom capability to enable region selection that is sufficient to support various levels of granularity. Accordingly, for example, a parent may be enabled to define relatively small areas of enablement for device usage of a mobile terminal belonging to a school aged child to limit the mobile terminal to usage between home and school or other frequented and approved areas. Enablement for implementing such limitations with respect to school age children may reduce the attractiveness of children as targets for crimes such as cell phone theft.

As an alternative to provision of a map for enabled region selection, the region manager 80 may provide a regional location listing from which enabled regions may be selected. For example, various hierarchies of regions may be provided (e.g., in alphabetical order) such that the user may browse through regions in an efficient manner and select those regions that are to be enabled. In this regard, a continent hierarchy may include each continent with a listing of countries therein. A country hierarchy may then include regions (e.g., states, counties, cities or other regions) within each respective country. Other hierarchical levels may also be provided with even finer detail (e.g., wards, districts or other segments within cities). As indicated above, selected regions may be highlighted, flagged or otherwise indicated as being enabled regions after selection.

As such, the region manager 80, whether by map or region listing, may provide a robust capability for users to define enabled regions. When the enabled regions have been selected, information defining the enabled regions may be stored (e.g., in the memory device 76) for comparison to current position for use in determining whether the mobile terminal 10 should be enabled for normal operation in the region in which the mobile terminal 10 is currently located. The comparisons and corresponding determinations regarding enablement of the mobile terminal 10 based on location may be handled by the security manager 82. In order to enter initial enabled regions or to modify the enabled regions after initial entry, the security code may be required. However, after entry of the enabled regions, the mobile terminal 10 may be operated normally within enabled regions without any requirement for entry of the security code.

The security manager 82 may be configured to compare current location to information defining the enabled regions in order to determine whether the mobile terminal 10 is currently within an enabled region. If the security manager 82 determines that the mobile terminal 10 is physically located within an enabled region, the security manager 82 may permit normal operation of the mobile terminal 10. However, if the security manager 82 determines that the mobile terminal 10 is not currently located within an enabled region, the security manager 82 may be configured to take some or all of the actions described herein.

In an exemplary embodiment, in response to a determination that the mobile terminal 10 is not within an enabled region, the security manager 82 may be configured to request entry of the security code. If the security code is entered, normal operation of the mobile terminal 10 may be enabled. However, as an alternative, entry of the security code may initiate operation of the region manager 80 to enable the user to define the current region as an enabled region or otherwise modify the current selection of enabled regions. In some cases, in response to a determination that the mobile terminal 10 is not within an enabled region, the security manager 82 may be configured to lock operation of the mobile terminal 10 with the exception of permitting entry of the security code. Thus, for example, a pop-up window or control console may be displayed to permit text entry of the code to unlock operation of the mobile terminal 10. However, text entry is not necessarily the only mechanism by which security code entry may be accomplished. In this regard, for example, the security code could be a bar code or other graphical element on the box that the mobile terminal 10 was packaged in when purchased. Thus, the user may be enabled to take a picture of or otherwise scan the bar code or graphical element to enter the security code. Other alternatives are also possible for entry of the security code such as voice samples or other potential inputs.

If, in response to a determination that the mobile terminal 10 is not within an enabled region, the security code is not entered, one or more of the following options may be implemented. In some embodiments, the security manager 82 may disable the mobile terminal 10. The disabling of the mobile terminal 10 may take many forms. In this regard, for example, a screen display requesting entry of the security code may be inescapably presented to the user to prevent usage of the mobile terminal 10 for anything other than security code entry. Alternatively, the mobile terminal 10 may be shut down or a message may be displayed indicating that the device is locked due to failure to enter a proper security code.

In some embodiments, the security manager 82 may be configured (e.g., by user settings or preferences) to provide a user selected delay prior to implementation of disabling of the mobile terminal 10. For example, a 24 hour delay or any other desirable delay period may be defined prior to disablement. Thus, in response to a determination that the mobile terminal 10 is not within an enabled region, the security manager 82 may issue a request for the user to enter the security code. The user may (e.g., due to the product box or information including the security code being at the user's home) bypass the entry of the security code for the defined delay period in order to permit the user to get back home to obtain the security code, but still have use of the mobile terminal 10 in the meantime. This functionality could also be used as an alternative to adding a new region to the list of enabled regions. For example, if the user is going on a weekend trip to a vacation destination that is not an enabled region, the user could define a 4 day delay period rather than add the destination location as an enabled region. When the user is in the destination location, the user may receive a request for entry of the security code and ignore or otherwise skip entry of the security code. The security manager 82 may then start a timer that is stopped in response to either entry of the security code or movement of the mobile terminal 10 back into an enabled region. Meanwhile, if the 4 day delay period is allowed to expire, the security manager 82 may assume the mobile terminal 10 is actually stolen or missing and disable the mobile terminal 10.

Other configuration options are also possible. For example, emergency calls may always be permitted, regardless of location. Additionally or alternatively, certain phone numbers or email addresses may always be enabled, regardless of location. For example, on a child's phone that may have relatively strict enabled region limitations, the phone number or email address of the child's parents may always be enabled regardless of the location of the phone. Furthermore, in some cases, after failure to receive proper entry of the security code, perhaps coupled with expiration of the delay period, the IMEI of the mobile terminal 10 may be reported to a black list database.

The location of the mobile terminal 10 may be provided by the positioning sensor 84. The positioning sensor 84 may include, for example, a GPS sensor, an Assisted-GPS (A-GPS) sensor, and/or the like. In some exemplary embodiments, the positioning sensor 84 includes a pedometer or inertial sensor. As an alternative, the positioning sensor 84 may include components enabling a determination of mobile terminal 10 position based on triangulation with respect to signals received from various sources, based on cell ID information or based on other mechanisms for locating mobile terminals such as cellular telephones. Accordingly, the positioning sensor 84 may be capable of determining a location of the mobile terminal 10, such as, for example, longitudinal and latitudinal location of the mobile terminal 10, or a position relative to a reference point such as a destination or start point or a point of interest. Information from the positioning sensor 84 may then, in some cases, be communicated to a memory of the mobile terminal 10 or to another memory device to be stored as a position history or location information. However, in some cases, information from the positioning sensor 84 may be communicated to the security manager 82 to determine whether the mobile device 10 is located in an enabled region.

When devices are stolen, one of the first things a sophisticated thief will likely do is to take the device offline, forge a new identity for the device and then bring the device back online. In the context of mobile phones or similar communication devices, this process typically involves operations such as powering the stolen device down, flashing new software into the device, deleting all user-related information, and writing a new identity (e.g., an IMEI) into the device (which in some cases may include writing the new IMEI on a sticker in the device). The process above is aimed at concealing the old identity and providing the device with a new and fraudulent identity. Accordingly, given that thieves instinctively attempt to erase traces of the old identity, embodiments of the present invention may either not provide the secret code in the mobile terminal at all, or may provide the security code quite deep within the hardware of the mobile terminal 10, and the processing of the security manager 82 may be accomplished as part of the boot sequence and secure execution environment so that reflashing or tampering with the memory of the mobile terminal 10 is not likely to break the protection offered. By making conversion of a stolen device into a useful device with a fraudulent identity a difficult or fruitless endeavor, embodiments of the present invention may reduce the incidence of device theft by deterrence.

In an exemplary embodiment, the apparatus 50 for providing a regional theft guard may be fully implemented on the mobile terminal 10, without any need for network involvement to offer protection. However, as indicated above, particularly in cases where the thief operates in an enabled region, embodiments of the present invention may incorporate protection enhancements with network involvement (e.g., the IMEI black list). Moreover, in an exemplary embodiment, the service platform 20 may offer enhanced services or capabilities in some cases. As an example, the service platform 20 may record a listing of countries that employ IMEI black list services with a central or local IMEI database. Thus, the service platform 20 may enable expansion of enabled regions to include all countries that provide IMEI black list services. The service platform 20 may also be configured to assist in registering the mobile terminal 10 on the IMEI database in response to failure of the user to enter the security code within the delay period.

Accordingly, embodiments of the present invention may provide a mechanism by which a regional theft guard can be provided to allow the user to define enabled regions. A comparison may thereafter be made to determine whether the user is currently in an enabled region and security measures may be implemented when the user is not in an enabled region. The comparisons may be made on a continuous, routine or periodic basis. However, in an exemplary embodiment, the comparisons may be made during the boot phase or whenever the subscriber identity module (SIM) card (or similar user identity card) is replaced. In embodiments where the IMEI database cannot be updated or checked, the standalone functionality of the apparatus 50 with respect to disabling the mobile terminal 10 in non-enabled regions may act as a complementary feature to IMEI blacklisting. Moreover, in some examples, the user may define a delay period before security functions are triggered. During the delay, the user may locate the security code, if it is not known. In this regard, for example, the user may call home to receive the security code from someone at home, or browse a home page associated with the user (e.g., at the service platform 20) to enable provision of the security code. As yet another alternative, the service platform 20 may host a service (e.g., the Ovi service) to enable provision of the security code to the mobile terminal 10 by storing the security code and providing an alternative authentication mechanism with the service, which if successfully completed may result in provision of the security code to the user.

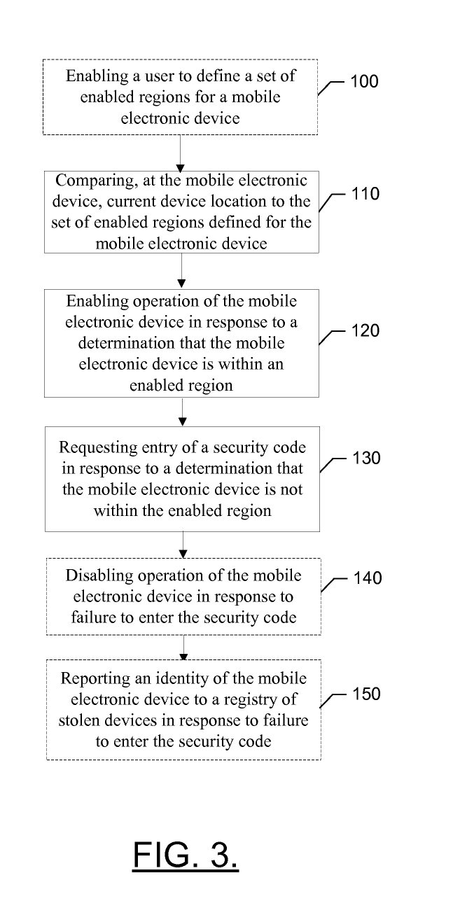

FIG. 3 is a flowchart of a system, method and program product according to exemplary embodiments of the invention. It will be understood that each block or step of the flowchart, and combinations of blocks in the flowchart, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory device of an apparatus employing an embodiment of the present invention and executed by a processor in the apparatus. As will be appreciated, any such computer program instructions may be loaded onto a computer or other programmable apparatus (e.g., hardware) to produce a machine, such that the resulting computer or other programmable apparatus embody means for implementing the functions specified in the flowchart block(s) or step(s). These computer program instructions may also be stored in a computer-readable storage memory (as opposed to a computer-readable transmission medium such as a carrier wave or electromagnetic signal) that may direct a computer or other programmable apparatus to function in a particular manner, such that the instructions stored in the computer-readable memory produce an article of manufacture the execution of which implements the function specified in the flowchart block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowchart block(s) or step(s).

Accordingly, blocks or steps of the flowchart support combinations of means for performing the specified functions, combinations of steps for performing the specified functions and program instruction means for performing the specified functions. It will also be understood that one or more blocks or steps of the flowchart, and combinations of blocks or steps in the flowchart, can be implemented by special purpose hardware-based computer systems which perform the specified functions or steps, or combinations of special purpose hardware and computer instructions.

In this regard, one embodiment of a method for providing a regional theft guard according to an exemplary embodiment, as shown in FIG. 3 includes comparing, at a mobile electronic device, current device location to a set of enabled regions defined for the mobile electronic device at operation 110 and enabling operation of the mobile electronic device (without entry of a security code) in response to a determination that the mobile electronic device is within an enabled region at operation 120. The method may further include requesting entry of a security code in response to a determination that the mobile electronic device is not within the enabled region at operation 130.

In some embodiments, the method may include additional optional operations, some examples of which are shown in dashed lines in FIG. 3. As such, for example, the method may further include an initial operation of enabling the user to define enabled regions for the mobile electronic device at operation 100. The method may further include disabling operation of the mobile electronic device in response to failure to enter the security code at operation 140. Additionally or alternatively, the method may further include reporting an identity of the mobile electronic device to a registry of stolen devices in response to failure to enter the security code at operation 150.

In some embodiments, certain ones of the operations above may be modified or further amplified as described below. Modifications or amplifications to the operations above may be performed in any order and in any combination. In this regard, for example, disabling operation of the mobile electronic device may include disabling operation of the mobile electronic device in response to failure to enter the security code within a predetermined delay period. The delay period may be a user entered value.

In an exemplary embodiment, enabling the user to define enabled regions may include enabling the user to select enabled regions from a map. Alternatively or additionally, enabling the user to define enabled regions may include enabling the user to select regions from a listing of regions. The listing of regions may be hierarchically organized based on geographical relationships between respective regions.

In an exemplary embodiment, an apparatus for performing the method of FIG. 3 above may comprise one or more processors (e.g., the processor 70) configured to perform some or each of the operations (100-150) described above. The processor may, for example, be configured to perform the operations (100-150) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 100-150 may comprise, for example, the processor 70, respective ones of the region manager 80, the security manager 82, and/or a device or circuit for executing instructions or executing an algorithm for processing information as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
comparing, at a mobile electronic device, current device location to a set of enabled regions defined for the mobile electronic device;
enabling operation of the mobile electronic device in response to a determination that the mobile electronic device is within an enabled region; and
requesting entry of a security code in response to a determination that the mobile electronic device is not within the enabled region.

2. The method of claim 1, further comprising enabling the user to define enabled regions for the mobile electronic device.

3. The method of claim 2, wherein enabling the user to define enabled regions comprises enabling the user to select enabled regions from a map.

4. The method of claim 2, wherein enabling the user to define enabled regions comprises enabling the user to select regions from a listing of regions.

5. The method of claim 4, wherein enabling the user to select regions from the listing of regions comprises enabling the user to select regions from regions that are hierarchically organized based on geographical relationships between respective regions.

6. The method of claim 1, further comprising disabling operation of the mobile electronic device in response to failure to enter the security code.

7. The method of claim 1, further comprising reporting an identity of the mobile electronic device to a registry of stolen devices in response to failure to enter the security code.

8. The method of claim 1, wherein disabling operation of the mobile electronic device comprises disabling operation of the mobile electronic device in response to failure to enter the security code within a predetermined delay period.

9. The method of claim 8, wherein disabling operation of the mobile electronic device in response to failure to enter the security code within the predetermined delay period comprises disabling operation of the mobile electronic device in response to failure to enter the security code within the predetermined delay period defined by a user entered value.

10. An apparatus comprising at least one processor and at least one memory including computer program code, the at least one memory and the computer program code configured to, with the at least one processor, cause the apparatus at least to:
compare, at a mobile electronic device, current device location to a set of enabled regions defined for the mobile electronic device;
enable operation of the mobile electronic device in response to a determination that the mobile electronic device is within an enabled region; and
request entry of a security code in response to a determination that the mobile electronic device is not within the enabled region.

11. The apparatus of claim 10, wherein the at least one memory and the computer program code are further configured to, with the at least one processor, cause the apparatus to enable the user to define enabled regions for the mobile electronic device.

12. The apparatus of claim 11, wherein the at least one memory and the computer program code are further configured to, with the at least one processor, cause the apparatus to enable the user to define enabled regions by enabling the user to select enabled regions from a map.

13. The apparatus of claim 12, wherein the at least one memory and the computer program code are further configured to, with the at least one processor, cause the apparatus to enable the user to define enabled regions by enabling the user to select regions from a listing of regions.

14. The apparatus of claim 13, wherein the at least one memory and the computer program code are further configured to, with the at least one processor, cause the apparatus to enable the user to select regions from the listing of regions by enabling the user to select regions from regions that are hierarchically organized based on geographical relationships between respective regions.

15. The apparatus of claim 10, wherein the at least one memory and the computer program code are further configured to, with the at least one processor, cause the apparatus to disable operation of the mobile electronic device in response to failure to enter the security code.

16. The apparatus of claim 10, wherein the at least one memory and the computer program code are further configured to, with the at least one processor, cause the apparatus to report an identity of the mobile electronic device to a registry of stolen devices in response to failure to enter the security code.

17. The apparatus of claim 10, wherein the at least one memory and the computer program code are further configured to, with the at least one processor, cause the apparatus to disable operation of the mobile electronic device by disabling operation of the mobile electronic device in response to failure to enter the security code within a predetermined delay period.

18. The apparatus of claim 17, wherein the at least one memory and the computer program code are further configured to, with the at least one processor, cause the apparatus to disable operation of the mobile electronic device in response to failure to enter the security code within the predetermined delay period by disabling operation of the mobile electronic device in response to failure to enter the security code within the predetermined delay period defined by a user entered value.

19. The apparatus of claim 10, wherein the apparatus is a mobile terminal and further comprises user interface circuitry configured to facilitate user control of at least some functions of the mobile terminal.

20. A computer program product comprising at least one computer-readable storage medium having computer-executable program code instructions stored therein, the computer-executable program code instructions including program code instructions to:
compare, at a mobile electronic device, current device location to a set of enabled regions defined for the mobile electronic device;
enable operation of the mobile electronic device in response to a determination that the mobile electronic device is within an enabled region; and
request entry of a security code in response to a determination that the mobile electronic device is not within the enabled region.
